(19) United States
(12) Patent Application Publication
(10) Pub. No.: US 2011/0211709 A1
(43) Pub. Date: Sep. 1, 2011

(54) HEADPHONES APPARATUS

(75) Inventors: MICHAEL SZOLGA, Enzersdorf an der Fischa (AT); Thomas Gmeiner, Vienna (AT); Dorian Staps, Munchen (DE)

(73) Assignee: AKG Acoustics GmbH, Vienna (AT)

(21) Appl. No.: 13/037,331

(22) Filed: Feb. 28, 2011

Related U.S. Application Data
(63) Continuation of application No. PCT/AT2009/000340, filed on Aug. 28, 2009.

(30) Foreign Application Priority Data
Aug. 28, 2008 (EP) EP 08450125.3

(51) Int. Cl. H04R 1/10

(52) U.S. Cl. 381/74

(57) ABSTRACT

The headphones apparatus has at least one ear cup, and at least one operating element coupled to the ear cup for the regulation of one or more audio functions. To facilitate the regulation for the user, the operating element can include an annular dial that is accessible from outside of the ear cup. The annular dial may be rotational, shiftable, tiltable, depressable, deformable, or any combination thereof, relative to the ear cup to operably regulate one or more audio functions of the ear cup.

### PRIORITY CLAIM

This application is a continuation, which claims the benefit of priority from International patent Application No. PCT/AT2009/000340, filed Aug. 28, 2009, which is incorporated by reference.

### BACKGROUND OF THE INVENTION

1. Technical Field

The invention relates to audio headphones, and more particularly, audio headphones having an earphone with an operating element for regulating an audio function.

2. Related Art

Headphones are worn by an end user to enable the user to listen to audio, such as music, produced by a digital storage and/or audio player device, such as a compact disc player or a MP3 player. MP3 is part of MPEG-1 Audio Layer 3 format for compressed audio signals. The headphones include earphones that are operatively coupled to the player device. The earphones are configured to produce audible sounds from electrical signals transmitted from the player device.

Earphones of some headphones can include operating elements, such as buttons or knobs, to affect the audio produced by the earphones. Multiple operating elements may be included on the earphones to control multiple functions of the audio. Because of the relatively small size and shape of the operating elements and different configurations of the operating elements, the user while wearing such headphones may find is difficult not only to locate the intended operating element, but also actuate the operating element in a suitable manner since the operating element is not visible to the user. For example, a returning knob usually provides only a marginal area for the user to grasp. As a result, the user may become frustrated with the headphones and unable to enjoy music when the tasks to change audio functions take longer than expected.

### SUMMARY

A headphones apparatus described herein can include an operating element coupled to at least one ear cup configured for audio. The operating element can be located intuitively by touch with one grasping movement by a user, and thus when worn by a user, the headphone apparatus can be controlled with certainty, reliably, and rapidly. One example of the operating element can include an annular dial that can be located externally adjacent to the ear cup in order to be accessible by the end user by locating the ear cup. The operating element may be rotational, shiftable, tiltable, depressable, deformable, or any combination thereof, relative to the ear cup to operably regulate one or more audio functions of the ear cup.

In one example, the annular dial may be spaced from an outer confronting surface of the ear cup. Rotation of the annular dial about the central axis can sequentially actuate control switches in a corresponding direction to operably regulate a first audio function of the ear cup. A portion of the operating element can be shiftable and/or tiltable relative to the ear cup to operably control a second audio function of the ear cup.

In another example, the operating element can include a closure device that is coupled to the ear cup and the annular dial. A control pin may be coupled between the closure device and the ear cup. At least one of shiftable and tiltable movement of the annular device and/or the closure device is operable to cause deflection of the control pin in a direction that selectively actuates at least one of the control switches corresponding to the direction of deflection. Additional control elements may be coupled to the closure device to regulate additional audio functions of the ear cup.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numeral designate corresponding parts throughout the different views.

FIG. 1 is a front view of one example of a headphones apparatus.

FIG. 2 is a side view of the headphones apparatus of FIG. 1.

FIG. 3 is a transverse cross-sectional view of one example of an operating element of the headphones apparatus of FIG. 1 coupled to one example of an ear cup.

FIG. 4 is an exploded perspective view of one example of the ear cup of FIG. 3.

FIG. 5 is a transverse cross-sectional view of one example of an operating element of the headphones apparatus of FIG. 1, without an ear cup.

FIG. 6 is a side view of another example of a headphones apparatus.

### DETAILED DESCRIPTION OF THE PREFERRED EMBODIMENTS

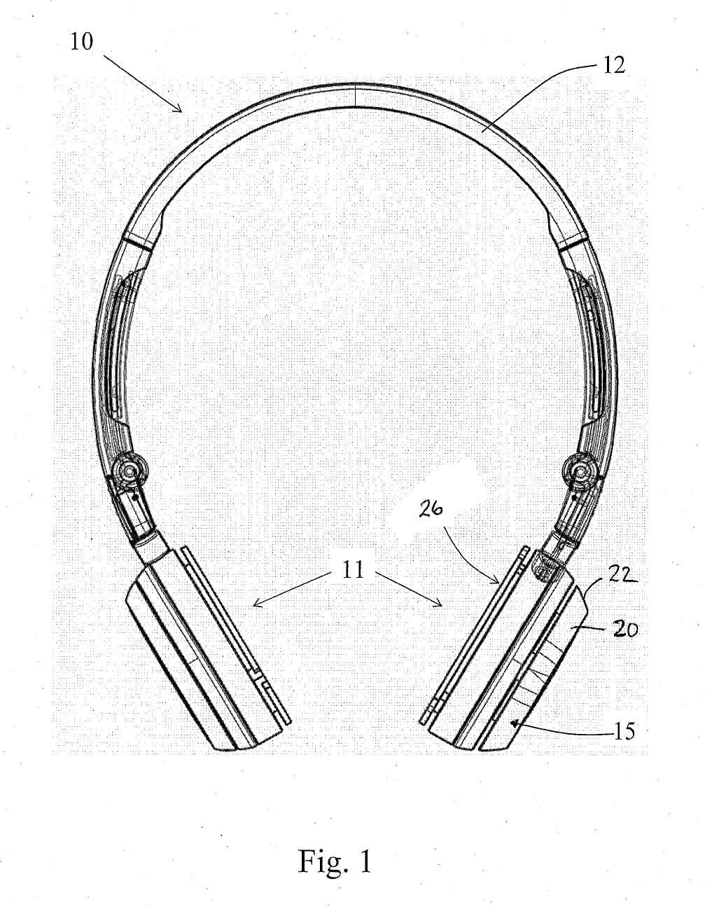

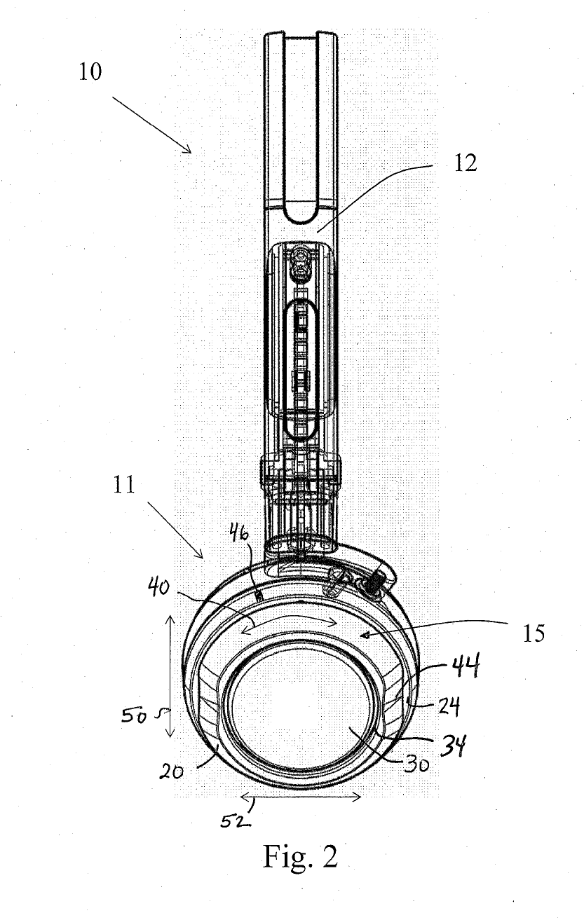

In FIGS. 1 and 2, one example of an audio headphones apparatus 10 can include two ear cups 11. Each of the ear cups 11 can be attached to one end of a support structure 12. In one example, the support structure can be an arc-shaped bow. The ear cups can be rotatably attached to the support structure 12 and may be rotatable about one or more axes. The ear cups may be permanently affixed to the headphones apparatus. In one example, the ear cups are removably attached to the headphones apparatus, for example, by mechanical fasteners.

The headphones apparatus 10 can include wires for transmission of power and/or audio signals both internal to the headphones and externally to an audio system. External communication may be with any protocol, such as, universal serial bus (USB), firewire, proprietary protocols, or any other communication protocol capable of audio data transmission to and from an audio system. An audio system may include one or more audio devices, such as compact disc (CD) player, an MP3 player, a digital versatile disc (DVD) player, a navigation system, an automobile head unit, a mobile communication device, a computer, and/or any other system or device capable of receiving and/or providing audio signals as analog or digital audio signals. In one example, the headphones apparatus 10 can include electrical conduits or conductors, and the ear cups 11 are operable for communication of data, control information, and/or power. Such electrical conductors can be coupled, encapsulated within, wrapped about, or otherwise carried by the headphones apparatus and coupled to the ear cups. In addition, the headphones apparatus can receive and provide wireless communication of the audio signals from and to an external audio system that includes one or more audio devices. Wireless communication may include Bluetooth™, infrared, WI-FI, or any other short range communication platform and/or protocol capable of communicating data digitally or in analog form, or some combination thereof. In addition, wireless communication may include long range communication platforms such as 3-G, 4-G, CDMA, or any other wireless communication protocol capable of communicating data over a wireless network digitally or in analog form, or some combination thereof. Thus, the headphones apparatus 10 may include an internal transceiver and may be operable to connect with an external transceiver and provide wireless two-way communication of data and/or control signals with one or more audio devices located geographically local, such as within a vehicle, or over a wireless network to audio devices located remotely from the headphones apparatus 10. The ear cups 11 may also have both wire and wireless capabilities to provide for any combination of local and remote two-way communication.

The headphones apparatus 10 may also include a processor and a memory. The processor may be a microprocessor, a digital signal processor, or any other form of computing device, and may include analog-to-digital and digital-to-analog converters, input/output capability, filtering, and any other digital and/or analog signal processing capability. The memory may include instructions, or code that is executable by the processor to provide the functionality of the headphones apparatus 10. The memory may be any form of non-transitory data storage device, such as a RAM, ROM, Flash Memory, or any other type of data storage device. Inputs and outputs processed by the processor using the instructions stored in the memory may include local input signals, externally provided and received input signals, audio signals, control signals, externally provided received control signals, switch closures, communication handshaking, communication protocol management, power saving features, or any other operational features present in the headphones apparatus 10. The processor may also execute instructions to provide a user interface capable of providing audible or visual indications, and receiving local inputs, such a audible inputs or input signals initiated by a user.

One or both ear cups 11 may include an operating element 15 that is operable to regulate one or more audio functions. In one example, the operating element 15 can include an annular dial 20 having a disc shape and an outer periphery 22 configured for handability by the end user. The annular dial 20 can be rotatably attached to one of the ear cups 11 and operable to regulate at least one audio function, such as the sound level produced by the ear cups. Other functions can include, for example, channel selection, title advance forward and backward, pairing, start, and stop, mute, command input, audio device selection, or any other function related to operation of the headphones apparatus within an audio system. Functionality of the annular dial 20 may be assigned by the user to any functionality of the headphones apparatus that is desired. Assignment of the functionality of the annular dial 20 may be via dip switches, audible commands, input signals initiated by the user, or downloaded settings, such as downloaded from a computing device. The assignment of the functionality of the annular dial 20 may be stored in the memory and used by the processor to interpret manual inputs by the user to the annular dial 20.

The operating element 15 can be coupled to the outside of the ear cup so that the operating element is externally accessible and can be intuitively located by touch with one grasping movement by a user. The operating element 15 may remain uncoupled mechanically from the outer surface of the ear cup. The operating element 15 can be coupled relative to an outer surface 24 of the ear cup 11 to form an outer most extremity of the ear cup 11. The operating element can be located outside relative to an inner portion 26 of the ear cup 11 that is to be placed against the head of the user. To this end, the operating element 15 may be visible and easily detectable by a user. The ear cup 11 may have a disc-shape having a first cross-sectional area. The annular dial 20 may have a second cross-sectional area approximately equal to the first cross-sectional area of the ear cup 11. The annular dial 20 may have a truncated cone shape, and may have a rounded, squared, or any other shape external contour. The attachment point between the support structure and the ear cup may be between the inner portion of the ear cup and the annular dial. The attachment point may reside within the housing of the annular dial. In one example, the diameter of the annular dial can be substantially equal to the outer circumference of the ear cup. This arrangement can make the headphones apparatus particularly ergonomic.

The external contour of the annular dial 20 may align substantially with the external contour of ear cup 11. In one example, the ear cup 11 (e.g., the right ear cup in FIG. 1) may have substantially the same external contour as the opposite ear cup (e.g., the left in FIG. 1). FIG. 1 depicts a lack of appreciable visual differences in the external contours of the ear cups. In one example, the annular dial 20 is sized to take minimal amount of space of the external side of the ear cup to limit the number of, and size of, protruding operating elements from the ear cup.

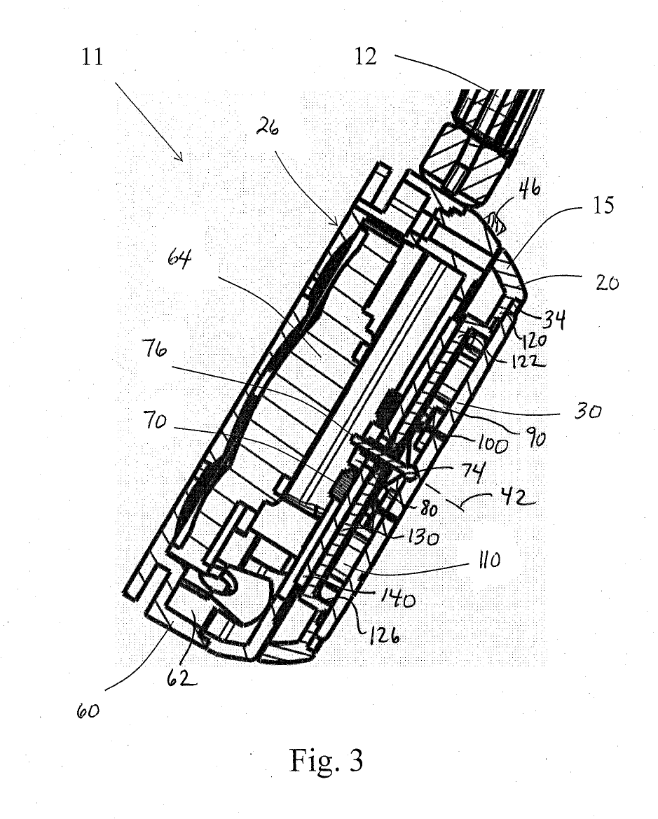

FIG. 2 is a side view of the headphones apparatus 10. The operating element 15 may be coupled to the outside surface 24 of the ear cup 11 with a closure device 30. The closure device 30 can be many shapes, such as a round disc. In FIG. 3, the annular dial 20 may have a recessed portion 34 on the outside surface. The recessed portion 34 is configured to receive and enclose the closure device 30. The closure device 30 can be securably attached to the ear cup 11 in a manner to retain the annular dial 20 and prevent detachment of the annular dial 20 during normal use and operation. The closure device 30 can remain in a fixed position relative to the rotation of the annular dial 20, or may be rotatable with the annular dial.

As indicated with the bent double arrow 40, the annular dial 22 can be rotated about a rotation axis 42 (FIG. 3) relative to a plane that is substantially parallel to the inner portion 26 of the ear cup. Surface irregularities 44 can be provided along the outer periphery 22 of the annular dial 20 to indicate through tactility the orientation and the relative current position of the annular dial 20. The surface irregularities 44 can include concavities, cuts, bevels, recesses, indentations, or the like formed in the outer periphery 22 of the annular dial 20. One or more deviating surface structures 46 can be provided on the ear cup 11, in place of or in addition to the surface irregularities, to indicate through tactility the orientation and the relative current position of the annular dial 20. The deviating surface structure 46, such as, for example, knobs, notches or grooves, may be provided along pre-determined positions on the outer circumference of the ear cup 11 proximate the annular dial 20.

In FIG. 2, one example of the operating element 15 can be shiftable relative to the ear cup 11, in place of or in addition to being rotatable, to regulate at least one audio function. For example, the annular dial 20 may be shiftable and/or tiltable relative to the plane defined by the outside surface 24 of the ear cup 11 along different axes, for example, as indicated by the vertical arrows 50 and the horizontal arrows 52, or any position between the axes. When the annular dial 20 is rotatable and shiftable and/or tiltable, the annular dial 20 is operable to regulate additional different audio functions, some audio functions may be controlled with rotation, such as to control the sound level produced by the ear cups 11, and some audio functions may be controlled with shiftability.

In one example, the closure device 30 may be movable independent of the annular dial 20 and operable to control at least one audio function. For example, the closure device 30 may be coupled to the ear cup 11 to be tiltable, shiftable, depressable, and/or deformable in different directions that correspond to different audio functions, such as, for example, channel selection, title advance forward and backward, pairing, start, and stop. This arrangement may be in addition to the rotatable annular dial 20 to control one or more audio functions. Other control elements, such as, for example, mutually independent (push) buttons, turning knobs, and similar parts, can be disposed on the closure device 30.

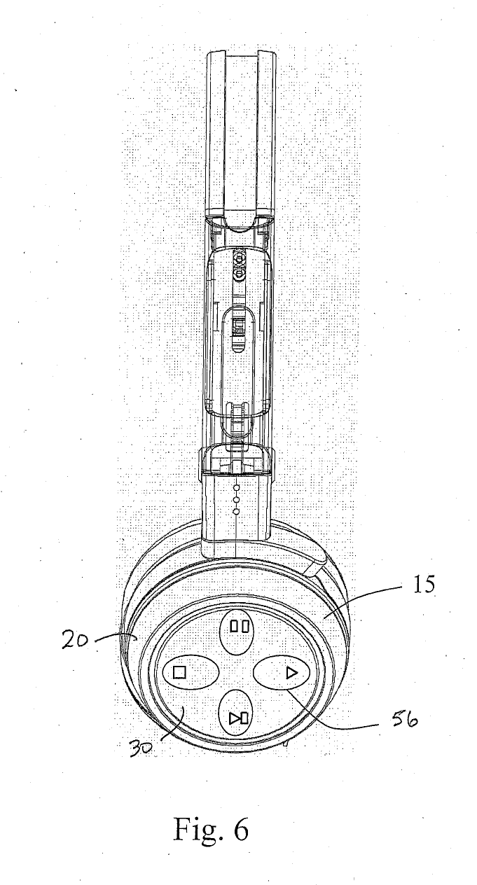

FIG. 6 illustrates one example of the closure device 30 of the ear cup 11 having four control elements 56, such as, for example, for play, stop, pause, and skip. In other examples, the control elements 56 or the tiltable shiftable closure device may include a selector to identify what function(s) are provided with the annular dial 20, such as a function to change a channel, and a function to adjust volume. In addition, other control elements 56 (not shown) may include one or more selector functionalities that allows a user to select various choices available, such as a button/switch selector function, a computer mouse type function, a roller ball type function, a touch pad type function, and/or any other form of user interface that allows receipt of user commands by the headphones apparatus 10.

In still other examples, the control elements 56 or the different directions of the tiltable shiftable closure device 30 may be assigned by the user to any functionality of the headphones apparatus 10 that is desired. Assignment of the control elements 56 or the different directions of the tiltable shiftable closure device 30 may be via dip switches, audible commands, input signals initiated by the user, or downloaded settings, such as downloaded from a computing device. The assignment of the control elements 56 or the different directions of the tiltable shiftable closure device 30 may be stored in the memory and used by the processor to interpret a signal representing a manual input by the user to one or more of the control elements 56.

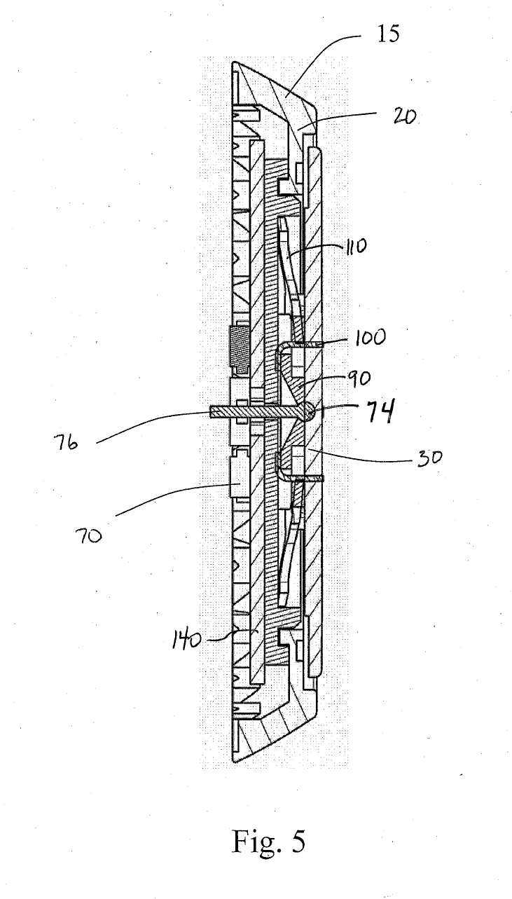

FIG. 3 is a transverse cross-sectional view of one example of the ear cup 11 coupled to the operating element 15, while FIG. 5 is a transverse cross-sectional view of another example of the operating element 15 without the ear cup. In FIG. 3, the ear cup 11 includes a housing 60 formed about a housing cavity 62. A sound producing element 64, such as one or more electroacoustic transducers, can be disposed within the housing cavity 62. An electronic circuit (not shown) can be disposed within the housing cavity 62 and include the processor and the memory. The electronic circuit can be operably coupled to the sound producing element 64, the operating element 15, and one or more control switches 70, such as microswitches and/or sensors that may be included in the operating element 15. Thus, actuation of the annular dial 20 can provide actuation of the control switches 70, resulting in the generation of the corresponding control signals that are transmitted to the electronic circuit and to the sound producing element 64. For example, rotation of the annular dial 20 can provide a sequential actuation of the control switches 70 in the corresponding direction of rotation. In another example, shifting, tilting, deforming, and/or depressing the annular dial 20 or the closure device 30 can provide actuation of at least one of the control switches 70 in the corresponding direction, or opposite direction of movement.

In FIGS. 3 and 5, a control pin 74 can be coupled to inner surface of the closure device 30 and can extend longitudinally along the central axis from the closure device 30 to proximate the control switches 70 to convert tiltable shiftable movement of the annular dial and/or closure device 30 to a control signal. For example, a first end 76 of the control pin 74 may be extended beyond the opening 80 formed by the control switches 70. The control switches 70 can be arranged to surround the control pin 74 and be spaced radially from the control pin 74. The relative position of the control pin 74 can actuate the control switches 70. The control pin 74 can be elongated body with an enlarged head portion that can be fixed to the lower surface of the closure device 30. In one example, the control pin 74 may be coupled to approximately the center of the closure device 30, and may define the rotation axis 42 of the annular dial 20.

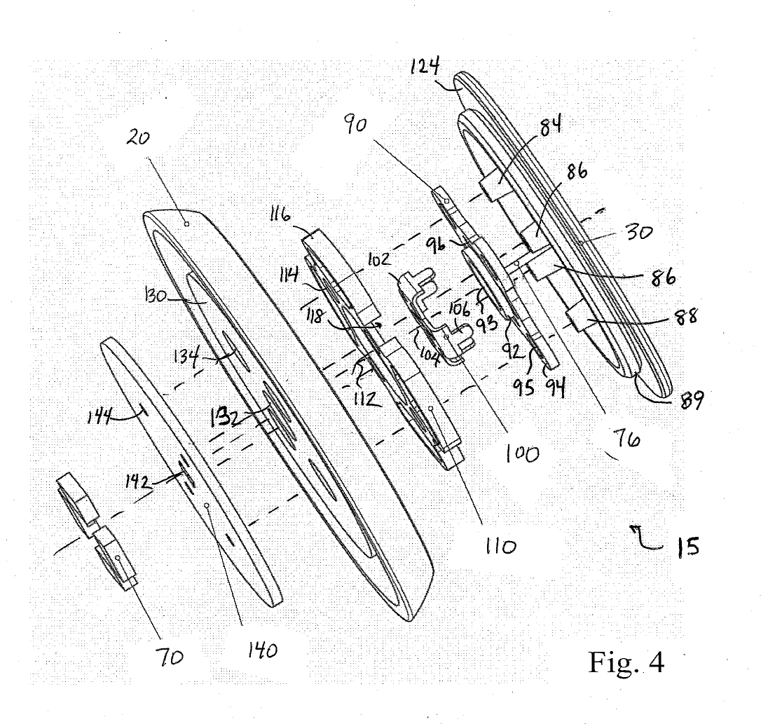

One or more protrusions, such as protrusions 82, 84, 86, 88 (FIG. 4), can be coupled to inner surface of the closure device 30 and can extend in a first longitudinal direction away from the closure device 30 toward the annular dial 20. The protrusions can be radially spaced from the control pin 72 by approximately the same distance. The protrusions may be arranged and oriented to define different axes, for example, a first axis as indicated by the vertical arrows 50 and a second axis as indicated by the horizontal arrows 52 in FIG. 2, or other differently arranged axes. For example, a pair of protrusions 82, 86 can define a first axis, and a pair of protrusions 84, 88 can define a second axis, substantially transverse to the first axis. An inner ring member 89 can be disposed at the inner surface of the closure device 30. The inner ring 89 can surround the protrusions 82, 84, 86, 88.

A transfer element 90 can be coupled to the closure device 30. In FIG. 4, the transfer element 90 can include a central hub 92 having a transfer element center opening 93 that is sized to receive the control pin 76. One or more ring elements, such as four ring elements 94, can be formed around the central hub 92. Each of the ring elements 94 can have a ring opening 95 that is sized to receive one of the protrusions 82, 84, 86, and 88. The transfer element 90 can be inserted over the protrusions and moved into close proximity to the lower surface of the closure device 30. The outer periphery of the transfer element 90 can be sized to fit within the inner circumference of the inner ring 89. Apertures 96 may be formed in the transfer element. The apertures 96 can be disposed outside the central hub 92, and may be circumferentially offset, e.g., about ninety degrees, from the ring elements 94.

A guide member 100 can be coupled to the closure device 30. The guide member 100 can be a disc-like member 102 having a guide central opening 104 to receive the control pin 76. One or more finger elements, such as four finger elements 106, are shown depending from the lower surface of the guide member 100 in a second longitudinal direction, opposite the first longitudinal direction, toward the closure device 30. Each of the finger elements 106 are sized to be received in the corresponding aperture 96 of the transfer element 90. The finger elements 106 can be spaced radially away from the guide central opening 104 and circumferentially spaced from one another to fit around the central hub 92 when coupled to the transfer element 90. The ends of the finger elements 106 can be embedded within the closure device 30.

An intermediate disc 110 can be coupled to the closure device 30. The intermediate disc 110 can include an intermediate disc central opening 112 formed therein that is sized to receive the control pin 76. The intermediate disc central opening 112 can be also sized to receive the outer cross-sectional of the guide member 100. One or more first peripheral bores, such as four first peripheral bores 114, can be formed around the intermediate disc central opening 112. Each of the first peripheral bores 114 is sized to receive one of the protrusions 82, 84, 86, and 88. The intermediate disc 110 can be inserted over the protrusions and moved into a close proximity to the lower surface of the closure device 30. The outer periphery of the intermediate disc 110 can be sized to fit within the inner circumference of the inner ring 89 of the closure device 30. The outer periphery 116 of the intermediate disc 110 may have one or more indentations, such as four indentations 118, formed radially inward into the outer periphery 116. Outward protrusions 119 may surround the indentations. The outward protrusions 119 may be oriented in alignment with the locations of the fingers of the guide, that is, about ninety degrees, from the protrusions 82, 84, 86, 88. In FIG. 5, the intermediate disc 110 can have a bowl shape to provide a pivot point for a tiltable closure device and/or a biasing member for a depressible closure device 30.

In FIG. 3, the recessed portion 34 of the annular dial 20 can include an outer flange portion 120 and an inner region 122 recessed below the outer flange portion 120. The outer flange portion 120 can be sized to receive an outer lip 124 of the closure device 30, which can extend radially beyond the inner ring 89 (FIG. 4). The inner wall 126 that defines the inner region 122 can be sized to receive the outer circumference of the inner ring 89. The inner region 122 can have a bottom wall 130. The bottom wall 130 may have an annular dial central opening 132 formed therein that is sized to receive the control pin 76. One or more second peripheral bores, such as four second peripheral bores 134, can be formed around the annular dial central opening 132.

The transfer element 90 and the guide member 100 can be disposed between the closure device 30 and the intermediate disc 110 to form a closure assembly that is sized to fit within the inner ring 89. The closure assembly 30 can be sized to fit within the recessed portion 34 of the annular dial 20 along an outer surface of the bottom wall 130, while still allowing the annular dial 20 to rotate with respect to the closure assembly 30.

A transmission element 140 can be disposed along an inner surface of the bottom wall 130. In one example, the transmission element is a circular plate that is coupled with and rotates with the annular dial 20. The transmission element 140 can include a transmission element central opening 142 formed therein that is sized to receive the control pin 76. One or more toggle elements 144 can be disposed around the transmission element central opening 142. The transmission element central opening 142 has a smaller diameter than the diameter of the central opening of the annular dial 20. The toggle elements 144 can be configured to complete open or closure of a corresponding one of the control switches 70. Examples of the toggle elements 144 can include a transistor, a mechanical element or a conductive element that is configured to operate as a switch to open or close a circuit.

In FIG. 3, the transmission element 140 can be placed within the housing of the ear cup 11. The control switches 70 may be placed on the inner side of the transmission element 140 farther within the housing of the ear cup 11. In FIG. 5, the transmission element 140 can be placed proximate the inner side of the annular dial 20. In this case, the control switches 70 can be arranged on the inner side of the annular dial 20 within the inner circumference of the annular dial 20 adjacent and proximate to the control switches 70. The inner side of the annular dial 20 can provide processes that actuate the control switches 70 sequentially when the annular dial is rotated. For example, during operation the annular dial 20 may be rotated such that the toggle elements 144 are rotated past the control switches 70. As the toggle elements 144 pass each of the control switches 70, the control switches 70 are actuated through a complete cycle, resulting in sequential actuation of the control switches 20 indicating not only a direction of rotation of the annular dial 20, but also a distance that the annular dial 20 is rotated.

To regulate one or more audio functions of the sound producing element of the ear cup, the annular dial 20 can be rotated, shifted, tilted, depressed, deformed, or any combination thereof, relative to the inner confronting surface of the ear cup. As a result, of the annular dial 20 or the closure device 30 being moved, such as shifted, tilted, depressed, deformed, or any combination thereof, the control pin 76 can move relative to the control switches 70 by being slightly bent. Slight bending of the control pin 76 may selectively actuating one or more of the control switches 70 indicating the direction movement applied by a user, and generating a corresponding control signal, which can be transmitted to the electronic circuit for regulation of at least one audio function of the sound producing element 64 of the ear cup 11. Repositioning of the control pin 76, such as by bending the control pin can actuate control switches 70 corresponding to the direction of the control pin 74 being slightly bent. Control switches 70 can produce control signals that can be sent to the processor for operation of the headphones apparatus, and/or for transmission to external audio systems.

Rotation of the annular dial 20 relative to the closure device 30 can actuate the control switches 70 sequentially via the transmission plate 140. For instance, the control switches may be fixed in a secure arrangement relative to the annular dial 20. It is also contemplated that the annular dial 20 may be pushed or moved inward to allow for free rotation of the annular dial 20 in order to actuate the control switches, and pushed outward, or allowed to return to a resting state, to inhibit free rotation.

In still another example, two pairs of protrusions that are arranged to define the first and second axes may be included on the annular dial 20. In the rest position, the protrusions can be placed in a close proximity with the toggle elements 144 for actuating the control switches 70 sequentially in the direction of rotation of the annular dial. In the rest position, the toggle elements 144 may be in operable position to actuate the control switches 70 to a predetermined state. Upon movement of the annular dial 20 or the closure device 30 by a user, such as, being shifted, tilted, depressed, or deformed, the annular dial 20 and/or the closure device 30 may be tilted or shifted in a direction to cause a corresponding first toggle element 144 to remain in contact with a corresponding control switch 70. In addition, an opposing second toggle element 144, opposite the corresponding first toggle element 144 may be removed from operable contact with a corresponding second control switch 70. Thus, a control signal is provided indicating the movement of the annular dial 20 and/or the closure device 30.

In another example, the annular dial 20 and/or closure device 30 can be tilted or shifted in a longitudinal direction. Shifting of the annular dial 20 can deform or bend the control pin 76 within the guide member 100 by moving the transfer element 90 to actuate toggle elements 144, depending on the direction of movement, and actuate corresponding control switches 70. In one example, the annular dial 20 can also be deformable and work in cooperation with corresponding ear cup side pressure sensors (not shown). The sensors can be located, for example, on the surface of the ear cup 11 that faces the inner side of annular dial 20. However, deformation of the annular dial 20 can also be performed by the control switches 70, such as opposing switches. Any movement/deformation of the annular dial 20 can be detected and processed with the control switches 70 with corresponding logic in the electronic circuit. Similarly, shifting, tilting, and/or deforming the closure device 30 relative to the annular dial 20 can move the control pin 76 to generate the corresponding control signals.

In another example, other control elements can be disposed on the closure device 30 and are operable independent of the movement of the annular dial 20 and/or closure device 30. For example, the control elements may be hard wired to the electronic circuit. The control elements can be actuated for regulation of audio functions.

The headphones apparatus can have a single ear cup. In this case, the support structure, e.g., the bow, either can extend around the head or can be clamped behind the ear. The headphones apparatus can be suitable for many applications, such as, for example, the automotive market, central management units, cockpits, locomotive driver cabins, and interpreters.

The operating element can be arranged on a side of the ear cup that is turned away from the ear to allow the user to recognize the operating element rapidly, which can be due to the annular shape. Thus, the entire outer side of the ear cup can be grasped by the user. The annular dial can be configured as large as possible for an audio function, such as sound level regulation. Due to the configured shape of the operating element, the user can intuitively identify the annular dial by touch and assign a corresponding function to the annular dial, such as sound level regulation. The tiltable, shiftable, depressable, and/or deformable operating element (annular dial and/or the closure device 30) can be manageable in an intuitively way by the user to prevent problems with the “mirror effect” with such an element. In other words, since the operating element is configurable, different functionality may be assigned to different locations as the user chooses so that the operating element may be position on either the left side, or the right side of the users head. Thus, the operating elements can be easy to handle, even when the user wearing the headphones apparatus may not see the operating element.

The operating elements on the respective headphones apparatus can be more easily located by the user and less confusion to operate. In the automotive market in particular, where the attention of the driver is diverted from other things when using a single-ear-cup headset, the operating element may be rapidly found and manipulated by the user. The operating element can increase the size of area available on the outer surface of the ear cup provided as a user interface.

While various embodiments of the invention have been described, it will be apparent to those of ordinary skill in the art that many more embodiments and implementations are possible within the scope of the invention. Accordingly, the invention is not to be restricted except in the light of the attached claims and their equivalents.

We claim:

1. A headphones apparatus comprising:
an ear cup configured for audio;
an operating element configured to regulate at least one audio function of the ear cup, the operating element having an annular dial defined about a central axis, the annular dial having an inner confronting surface in a longitudinally spaced relationship with an outer confronting surface of the ear cup; and
a plurality of control switches, where rotational movement of the annular dial about the central axis sequentially actuates the control switches in a corresponding direction to operably regulate a first audio function of the ear cup, and at least one of shiftable and tiltable movement of a portion of the operating element relative to the ear cup operably controls a second audio function of the ear cup.

2. The apparatus of claim 1, where the operating element further comprises a control pin extending along the central axis from the inner confronting surface of the annular dial, the control pin having a first end fixed to the ear cup, and a second end fixed to the operating element.

3. The apparatus of claim 2, where the annular dial rotates around the control pin, and the at least one of shiftable and tiltable movement of the portion of the operating element is operable to cause deflection of the control pin in a direction that selectively actuates at least one of the control switches corresponding to the direction of deflection.

4. The apparatus of claim 1, the operating element further comprises a transmission element disposed between the control switches and the annular dial, and coupled to the annular dial, the transmission element having a plurality of toggle elements, where, in response to rotation of the transmission element, the toggle elements sequentially actuate the control switches.

5. The apparatus of claim 1, where the operating element further comprises a closure device coupled to the annular dial opposite the outer confronting surface of the ear cup.

6. The apparatus of claim 5, where the annular dial is rotatably movable relative to the closure device.

7. The apparatus of claim 5, where at least one of the closure device and the annular dial is at least one of shiftable and tiltable relative to the annular dial to operably control the second audio function of the ear cup.

8. The apparatus of claim 7, where the operating element further comprises a control pin extending along the central axis from the closure device, the control pin having an end fixed to the ear cup, and where at least one of the closure device and the annular dial is at least one of shiftable and tiltable relative to the annular dial to cause deflection of the control pin in a direction that selectively actuates at least one of the control switches corresponding to the direction of deflection.

9. The apparatus of claim 5, where the at least one operating element further comprises one or more control elements coupled to the closure device to operably regulate one more additional audio functions of the ear cup.

10. The apparatus of claim 1, where the control switches are coupled to the ear cup.

11. The apparatus of claim 1, where the control switches are coupled to the housing of the annular dial.

12. The apparatus of claim 1, where the outer confronting surface of the ear cup enclosed by the annular dial is uncoupled mechanically from the rotary motion of the annular dial.

13. A headphone apparatus comprising:
an ear cup configured for audio;
an operating element configured to regulate at least one audio function of the ear cup, the operating element including an annular dial defined about a central axis and a control pin, the annular dial coupled to the ear cup such that an inner confronting surface of the annular dial is in a longitudinally spaced relationship with an outer confronting surface of the ear cup, the control pin extending from the inner confronting surface of the annular dial and having an end coupled to the ear cup; and
a plurality of control switches fixedly arranged to surround and radially spaced from a segment of the control pin, where rotational movement of the annular dial about the central axis sequentially actuates the control switches in a corresponding direction to operably control a first audio function of the ear cup, and at least one of shiftable and tiltable movement of a portion of the operating element relative to the ear cup causes deflection of the control pin relative to at least one of the corresponding control switches corresponding to a direction of deflection to operably regulate a second audio function of the ear cup.

14. The apparatus of claim 13, where the operating element further comprises a transmission element disposed between the control switches and the annular dial, and coupled to the annular dial, the transmission element having a plurality of toggle elements and a central opening to receive the control pin, where, in response to rotation of the transmission element, the toggle elements sequentially actuate the control switches in a direction of rotation.

15. The apparatus of claim 13, where the operating element further comprises a closure device fixedly coupled to the ear cup so that the annular dial is rotatable between the ear cup and the closure device.

16. The apparatus of claim 15, where the control pin extends from the closure device and includes an end that is secured to the ear cup in a fixed position.

17. The apparatus of claim 16, where the closure device is at least one of shiftable and tiltable relative to the annular dial to deflect the control pin in a direction for selective actuation of at least one of the control switches corresponding to the direction of deflection to operably regulate a third audio function of the ear cup.

18. The apparatus of claim 13, where the annular dial is the portion of the operating element that causes deflection of the control pin relative to at least one of the corresponding control switches corresponding to a direction of deflection.

19. A headphone apparatus comprising:
an ear cup configured for audio;
an operating element configured to regulate at least one audio function of the ear cup, the operating element having an annular dial defined about a central axis and a closure device, the annular dial coupled to the ear cup such that an inner confronting surface of the annular dial is in a longitudinally spaced relationship with an outer confronting surface of the ear cup, the closure device coupled to an outside surface of the annular dial opposite the ear cup; and
a plurality of control switches, where rotational movement of the annular dial about the central axis sequentially actuates the control switches in a corresponding direction to operably control a first audio function of the ear cup, at least one of shiftable and tiltable movement of the annular dial relative to the ear cup operably controls a second audio function of the ear cup, and at least one of shiftable and tiltable movement of the closure device relative to the ear cup operably controls a third audio function of the ear cup.

20. The apparatus of claim 19, where the operating element further comprises a control pin coupled to the closure device, the control pin extending along the central axis of the annular dial and having an end fixed to the ear cup.

21. The apparatus of claim 20, where deflection of the control pin in a direction in accordance with movement of the closure device or the annular dial selectively actuates at least one of the control switches corresponding to the direction of deflection.

22. The apparatus of claim 19, where the operating element further comprises a transmission element disposed between the control switches and the annular dial, and coupled to the annular dial, the transmission element having a plurality of toggle elements, where, in response to rotation of the transmission element, the toggle elements sequentially actuate the control switches.

23. The apparatus of claim 19, where the closure device is deformable in at least one place for the regulation of additional audio functions.

24. The apparatus of claim 19, where the ear cup has a first outer diameter, and the annular dial has a second outer diameter substantially equal to the first outer diameter.

25. The apparatus of claim 19, where the ear cup is a first ear cup, the apparatus further comprising a support structure having a first end and a second end, and a second ear cup, each of the first and second ear cups having an inner listening side and opposite outer side, the first ear cup attached to the first end of the support structure and the second ear cup attached to the second end of the support structure.
